(19) United States
(12) Patent Application Publication
(10) Pub. No.: US 2005/0221016 A1
(43) Pub. Date: Oct. 6, 2005

(54) Methods for modifying carbon nanotube structures to enhance coating optical and electronic properties of transparent conductive coatings

(76) Inventors: Paul J. Glatkowski, Littleton, MA (US); Michael C. Trottier, Saunderstown, RI (US)

Correspondence Address: MORRISON & FOERSTER LLP, 1650 TYSONS BOULEVARD, SUITE 300, MCLEAN, VA, 22102, US

(21) Appl. No.: 11/024,938

(22) Filed: Dec. 30, 2004

Related U.S. Application Data
(60) Provisional application No. 60/533,248, filed on Dec. 31, 2003.

(51) Int. Cl. B05D 3/00

(52) U.S. Cl. 427/444

(57) ABSTRACT

This invention is directed to a method of increasing the optical and electrical properties of carbon nanotube based transparent electrically conductive coating/films by modification of the applied single wall carbon nanotube (SWCnT) network through use of solvents and/or an expendable matrix structure.

### BACKGROUND

1. Field of Invention

This invention is directed to methods of increasing the optical and electrical properties of carbon nanotube-based transparent electrically conductive coating and films by modification of the carbon nanotube network through use of solvents and/or an expendable matrix structures.

2. Description of the Background

Current transparent conductive coatings utilize Indium Tin Oxide (ITO) coatings applied to an optically transparent substrate by physical vapor deposition processes, primarily sputtering. These processes require considerable capital expenses and are difficult to scale up. Alternatively, utilizing single wall carbon nanotube as the transparent conductor produces materials that closely match the properties of ITO in transparent conductive applications and are more cost effectively produced and are far more flexible. Critical to applying SWCnT transparent conductive coatings is the ability to purify the SWCnT starting material. This requires the removal of other forms of carbon that are produced during the formation of carbon nanotubes. Furthermore, the coating of pure nanotubes forms a uniform network of ropes tightly interconnected across the surface. FIG. 1 shows a field emission micrograph of a SWCnT transparent conductive network on polyethylene terephthalate (PET) sheet. Ultimately, the purity, application method, and post processing of these coatings are critical to achieving performance and cost objectives.

### SUMMARY OF THE INVENTION

The present invention overcomes the problems and disadvantages associated with current strategies and designs, and provides new tools and methods of increasing the optical and electrical properties of carbon nanotube-based transparent electrically conductive coatings and films by modification of carbon nanotube network through with solvents and/or expendable matrix structures.

One embodiment of the invention is directed to improvements in optical, mechanical, and electrical properties of carbon nanotube coatings. One such method comprises incorporation of an expendable/fugitive matrix material into coating, during formation of the SWCnT layer, the fugitive material is subsequently removed. During removal of the fugitive matrix, extraction of contaminates and facilitation of network formation may be achieved.

Another embodiment of the invention is directed to methods of post treatment of the existing nanotube conductive network (which is for a layer that does not contain a fugitive matrix material) by emersion of the coating/layer in a solvent and subsequent drying to allow relaxation and reorganization of the ropes which form the conductive network of nanotubes.

The expendable matrix may comprise a water soluble material, but is preferably removable using common aqueous cleaning methodologies, such as dipping, low pressure rinsing; or using other methods of remove the material such as, for example, ultrasonic agitation, evaporation, sublimation, decomposition (by heating, e-beam, EM radiation, or any method of imparting energy to the surface), thermal heating, vacuum, radiation, ion etching, plasma etching, chemical reaction. Other expendable matrix materials include soluble polymers, organic compounds, acids, salts, inorganic compounds, waxes, ceramics, and the like. The expendable matrix material is preferably removable from the SWCnT network without damaging the substrate. In the case where glass is used as a substrate, removal of expendable matrix can be performed with very aggressive techniques such as high temperatures. For example, the use of block copolymer surfactants as one example, since there can be incremental variations made to the surfactant chemistry to improve wetting, optical and rinsing (e.g. cleaning) properties. These properties are tailored to the design performance metrics required by the transparent conductive coating, that is, transparency and sheet resistance.

Other embodiments and advantages of the invention are set forth in part in the description, which follows, and in part, may be obvious from this description, or may be learned from the practice of the invention.

### DESCRIPTION OF THE FIGURES

FIG. 1. FESEM micrograph showing the single wall carbon nanotube applied to PET substrate.

FIG. 2. Schematic of Collapsing Nanotube Structure.

FIG. 3. Effect of resistance after rinsing glass slide for 1 minute with no agitation at 25° C.

FIG. 4. Effect of resistance after rinsing glass slide for 1 minute with no agitation at 25° C.

### DESCRIPTION OF INVENTION

Performance of SWCnT transparent conductive coatings is directly tied to uniform and controlled application of high purity SWCnT material. Incorporating a temporary and/or expendable matrix into SWCnT coating formulations such as, for example, one containing one or more non-ionic surfactants, is one way to achieve this. These PLURONIC™ surfactants, manufactured by BASF, are versatile in that the molecular weight between the hydrophobic and hydrophilic groups can be selected to meet the requirements of the coating system. They contain propylene oxide with two hydroxyl groups of propylene glycol sandwiched with ethylene oxide. A major advantage to this invention is that the process is not limited to a specific substrate material and the matrix chemistry can be washed away.

Methods are provided to facilitate improvements in optical, mechanical, and electrical properties of carbon nanotube coatings. In one method, incorporation of an expendable and/or fugitive (meaning temporary or removable) matrix material into coating, during formation of the SWCnT layer, the fugitive material is subsequently removed. During the removal of the fugitive matrix, extraction of contaminates and facilitation of network formation is achieved. In another method, post treatment of the existing nanotube conductive network (which is the layer that does not contain a fugitive matrix material) by emersion of the coating/layer in solvent and subsequent drying to allow relaxation and reorganization of the ropes which form the conductive network of nanotubes.

The expendable matrix may comprise a water soluble material, but is preferably removable using common aqueous cleaning methodologies, such as dipping, low pressure rinsing; or using other methods of remove the material such as, for example, ultrasonic agitation, evaporation, sublimation, decomposition (e.g. by heating, e-beam, EM radiation, or any method of imparting energy to the surface), thermal heating, vacuum, radiation, ion etching, plasma etching, chemical reaction. Other expendable matrix materials include: soluble polymers, organic compounds, acids, salts, inorganic compounds, waxes, ceramics, and the like. The expendable matrix material is preferably removable from the SWCnT network without damaging the substrate. In the case where glass is used as a substrate, then removal of expendable matrix can be removed using very aggressive techniques such as high temperatures.

For example, the use of block copolymer surfactants is presented, as one example below, since there can be incremental variations made to the surfactant chemistry to improve wetting, optical and rinsing (cleaning) properties. These properties are tailored to the design performance metrics required by the transparent conductive coating, for example, transparency and sheet resistance.

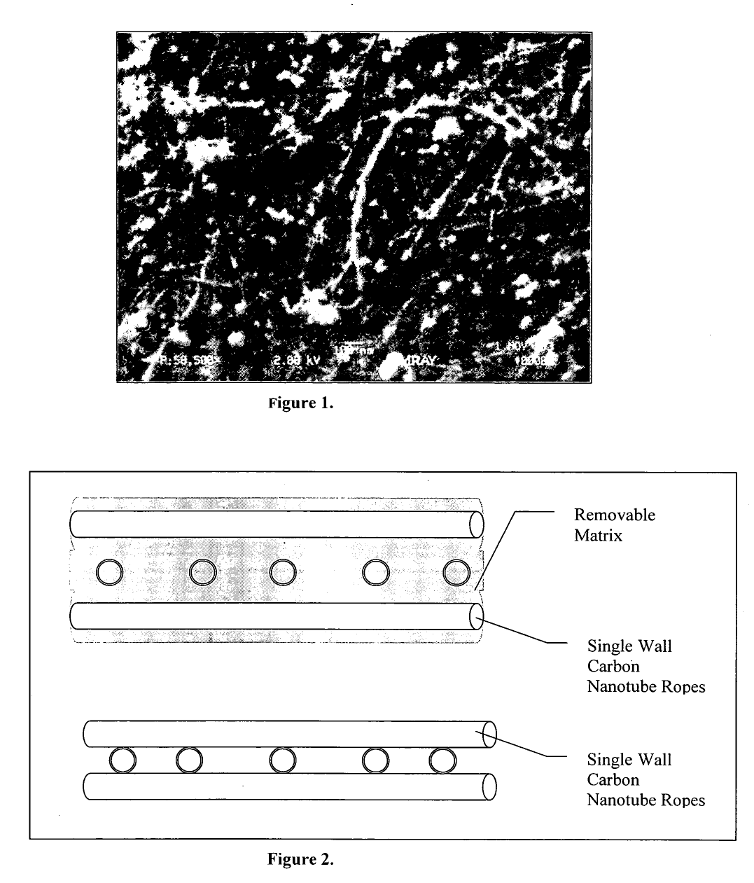

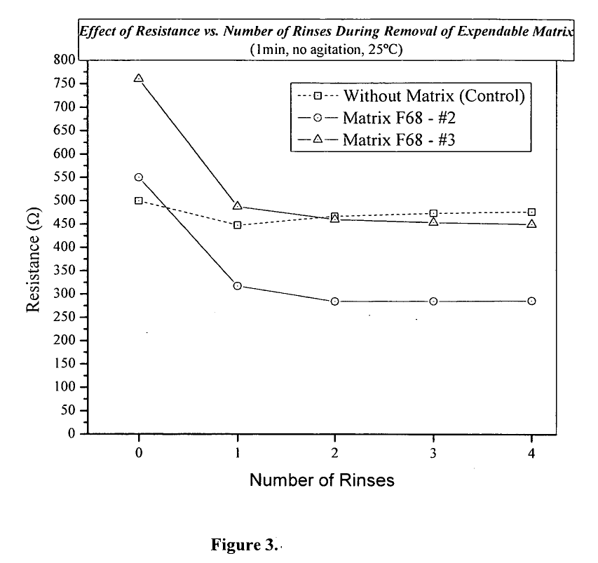

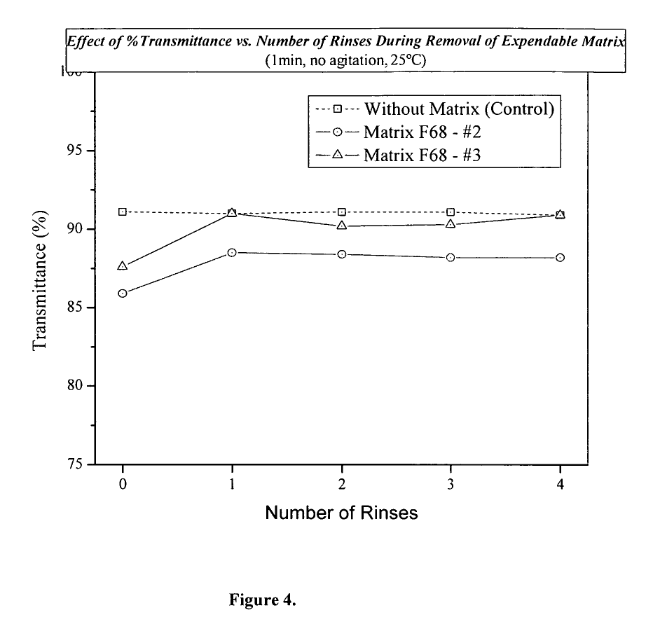

One embodiment of this invention comprises taking an expendable matrix of a surfactant and incorporating that matrix into a SWCnT solution or ink. The carbon nanotubes and other impurities are mixed with the matrix material resulting in stable ink dispersion. The ink is applied to the optically transparent substrate, like PET film, in such a way to insure proper wetting and uniform coverage during application. These parameters are tailor to substrate and coating performance. After application, the end result is a coating that contains SWCnT in a surfactant matrix. Some electrical and optical properties are achieved, but the matrix minimizes the contact between adjacent carbon nanotubes, see FIG. 2. Aqueous rinsing is used to remove the matrix from SWCnT at room temperature. The matrix dissolves into the rinse solution, cleaning the surface of the carbon nanotubes. The tubes then collapse onto each other, increasing the number of conductive paths without significantly changing the optical properties, see FIG. 3 and FIG. 4. The formation of a conductive network of SWCnT has fewer defects over that obtained without the use of the fugitive matrix material and results in lower electrical resistivity in the layer containing the same amount of nanotubes.

Another benefit using an expendable matrix is the removal of other contaminates, remaining from the ink formulation/purification process. These contaminates do not contribute to electrical conduction and retard optical transparency. Since the SWCnTs ropes are physically intertwined around each other, to form essentially a non-woven mat, the network remains intact during rinsing. However, other forms of carbon, more spherical in geometry, that are not part of the network are removed during the rinsing process. Thus, a more purified transparent conductive coating is achieved.

Another embodiment of this invention comprises using solvent, preferable water, to wet a SWCnT coating which was deposited from a solution containing only the carbon nanotubes and possibly other forms of carbon present as containments. In the previous example, a fugitive material was added during formation of the network, however in this invention, the network is allowed to form without any other matrix material present. For example, purified carbon nanotubes can be dispersed in a volatile solvent like water or alcohol and then sprayed onto a transparent substrate. The wet coating which forms can be made to dry leaving only a layer of nanotubes on the surface which forms an electrically conductive network that when deposited at a thickness less than about 1 micron, preferably less than about 100 nm, is also transparent to light. The resulting electronic and optical properties of the nanotube layer are strongly dependent on how densely interconnected the nanotube layer forms. The formation of this network of single walled carbon nanotube ropes is driven by van der Waals attractions between the sidewalls of the individual nanotubes comprising the ropes. During drying of the wet film, the nanotubes are attracted to each other and consolidate into the lowest possible energy configuration which minimizes free surfaces and maximizes interconnectivity between ropes of nanotubes. During drying the nanotube ropes have a limited about of time to minimize energy, reconfigure, move about, and consolidate while being constrained by entanglements and hindrances from the boundary conditions imposed by the substrate surface and fluid surface. Although it is possible to optimize the drying conditions to allow for the highest optical and electrical properties, it is not always possible in the commercial production environment to allow for the best drying conditions. Consequently when forming transparent conductive coating from carbon nanotubes a wide range of electrical resistivity and optical transparence performance is possible from a coating with the only difference being in the way the nanotube network forms on the surface. If the coating of nanotubes is not allowed to completely consolidate then the resulting optical and electrical properties will be reduced, however this can be corrected by rewetting the surface with a volatile solvent like water to allow the consolidation to continue resulting in a coating with higher transparency and lower electrical resistivity.

In practice this invention is valuable in any coating process where the carbon nanotube layer is formed during a rapid deposition and drying process like spray coating, inkjet printing, roll coating. The method described herein allows the deposition and drying of the nanotubes onto the surface quickly and therefore not optimally for electrical and optical performance, while providing a means as a second process step of achieving higher electrical and optical performance. For example, one likely approach to forming transparent conductive patterns or circuits of carbon nanotubes is the use of inkjet technology. However inkjet application over large areas in commercial production often results in rapid drying of the deposited droplets. This rapid drying will result in reduced electrical and optical performance of the pattern or circuit. The rapid drying allows for increased production rates and deposition of multiple layers. The reduced performance of the transparent conductive layer can be correct by rewetting the surface and allowing the nanotube to continue consolidating to improve performance characteristics. The rewetting can be accomplished by dipping, spraying, condensing, and flowing fluid onto the network of nanotubes one to ten times with rapid drying. The rewetting of the surface also serves to wash away contaminates like non tubular forms of carbon, metals catalyst particles, amorphous carbon particles, and other additives like surfactants, dispersing agents, acids, bases, salts, organic compounds, inorganic compounds, biological based molecules, proteins, and other materials. The rewetting can also be performance selectively on the surface to change the electrical and optical characteristics of the coating nanotubes from one area to the next.

The formed network is then modified by the wetting step. The conductive network is formed on the transparent substrate and dried. The coating is then wet by rinsing with water and then dried. The rewetting of the SWCNT layer allows the network to reorganize and relax to form a layer with superior electrical properties and higher optical transparency. An experiment showing this method is presented in Example 1.

In practice this invention is valuable in any coating process where the carbon nanotube layer is formed during a rapid deposition and drying process like spray coating, inkjet printing, roll coating. The method described herein allows the deposition and drying of the nanotubes onto the surface quickly and therefore not optimally for electrical and optical performance, while providing a means as a second process step of achieving higher electrical and optical performance.

For example, one likely approach to forming transparent conductive patterns or circuits of carbon nanotubes is the use of inkjet technology. However inkjet application over large areas in commercial production often results in rapid drying of the deposited droplets. This rapid drying will result in reduced electrical and optical performance of the pattern or circuit. The rapid drying allows for increased production rates and deposition of multiple layers. The reduced performance of the transparent conductive layer can be correct by rewetting the surface and allowing the nanotube to continue consolidating to improve performance characteristics. The rewetting can be accomplished by dipping, spraying, condensing, and flowing fluid onto the network of nanotubes one to ten times with rapid drying. The rewetting of the surface also serves to wash away contaminates like non tubular forms of carbon, metals catalyst particles, amorphous carbon particles, and other additives like surfactants, dispersing agents, acids, bases, salts, organic compounds, inorganic compounds, biological based molecules, proteins, and other materials. The rewetting can also be performance selectively on the surface to change the electrical and optical characteristics of the coating nanotubes from one area to the next. The formed network is then modified by the wetting step. The conductive network is formed on the transparent substrate and dried. The coating is then wet by rinsing with water and then dried. The rewetting of the SWCNT layer allows the network to reorganize and relax to form a layer with superior electrical properties and higher optical transparency. An experiment showing this method is presented in Example 1.

The post treatment of spray coated SWCnT coatings on a transparent substrate to increase optical and electrical performance is surprising and unexpected. They method of treating the SWCnT layer is performed prior to over coating the layer for environmental protection as is typically done using polymeric materials. Interestingly the act of over coating with polymers (containing solvents) to protect the conductive SWCnT network does not increase the electrical or optical performance significantly. This further indicates that the procedure/method includes the step of removal of matrix material. The wetting step in the procedure can be done with a variety of fluids including, but not limited to organic solvents, polymers, inorganic materials, oligamers, waxes, hydrocarbons. Furthermore it is anticipated that the wetting agent could be moved by any means which does not damage the SWCnT network. Means of removal of the wetting agent include: evaporation, sublimation, decomposition.

The following examples illustrate embodiments of the invention, but should not be viewed as limiting the scope of the invention.

### EXAMPLES

### Example 1

### Use of Water and Standard Laboratory Branson Ultrasonic Bath to Increase Transparence and Reduce Resistivity in CNT Coated PET Film

The experiment started with a 5-mil PET film ST 505 film, having bands of silver paint placed four inches apart to form a square area for testing. The entire PET film was spray coated with Eikos' SWCnT ink (SWCnT suspend in water/alcohol solvent) using an airbrush (i.e. Paasche VLS#3) to a surface resistivity of below 500 Ohms/Square. This sample was then died in air at 100° C. for 10 minutes. The electrical and optical properties were then measured in air. The sample was then placed in a round glass container filled with purified water. The ultrasonic bath was turned on and the container with the film sample was lowered into the bath for the stated seconds. The film was then dried in air for 10-minutes before taking the next resistance reading.

The SWCnT coated PET sample that did not have a binder improved in both transparency and electrical properties using water and short ultrasonic bath exposures. The transparency and Ohms/Square did not appear to improve after the first 13 seconds of exposure.

### Example 2

### Glass Slides Coated with CNT and Rinsed to Increase Optical Transparency and Reduce Electrical Resistivity

Four experimental trials applying the methods described above to increase optical and electrical performance of SWCnT coatings.

In trials #1 and #2, arc produced single walled carbon nanotube soot containing approximately 50-60% carbon nanotubes was purified by refluxing in 3M nitric acid solution for 18 hours at 145±15° C. The mixture was rinsed and centrifuged to produced an ink solution containing >99% single walled carbon nanotubes at a concentration of 0.189 g/L (ink solution “A”).

The ink formulations sprayed in trials #1 and #2 were performed utilizing an airbrush at 25-30 psi air assist pressure onto a heated (75° C.) 1″×3″ glass slide with silver electrodes spaced 1″ apart. The spacing provides two (2) measurements of sheet resistance and percent transmitted light on each slide. The application of SWCnT was performed until a predetermined amount (see trials) was applied to the glass substrate. The sheet resistance was measured using a 2 point probe ohmmeter and the light transmittance measured using a spectrophotometer at wavelength 550 nm. Measurements were taken at two (2) positions on the glass.

Trial 1

Formulation of Ink (T1):

5 ml ink solution “A”
8.8 ml Methanol
25 ml stock solution (1.75:1 methanol/DI water)
SWCnT concentration in ink formulation was measured at 0.028 g/L (Absorbance=0.9)
   Trial 2
   Formulation of Ink (T2):
5 ml ink solution “A”
10 ml Methanol
5 ml stock (2:1 methanol/DI water)
SWCnT concentration in ink formulation was measured at 0.038 g/L (Absorbance=1.3)
Note: Spray gun was cleaned/sonicated to remove all contaminants.

Methanol sprayed through line prior to spraying.

In trials #1 and #210 ml of the SWCNT ink solution T1 and T2 was applied to a glass slide, respectively. The sheet resistance was measured using a 2 point probe ohmmeter and the percent light transmitted was measured using a spectrophotometer. Next, the slide(s) was immersed in DI water for 1 minute, allowed to air dry and measured for sheet resistance and light transmittance. This process was repeated for a second rinse. The data is presented in the Table III and Table IV for each trial #1 and #2 respectively. As shown in reduction in sheet resistance and increase in percent light transmittance, dipping the coated glass slide in water allows the carbon nanotube network to reassemble (providing more contact between carbon nanotubes and ropes) while removing other impurities (which absorb light) not attached to the nano-fibrous network.

Trial 3

In trials #3, arc produced single walled carbon nanotube soot containing approximately 50-60% carbon nanotubes was purified by refluxing in 3M nitric acid solution for 18 hours at 145±15° C. The mixture was rinsed and centrifuged to produced an ink solution containing >99% single walled carbon nanotubes at a concentration of 0.353 g/L (ink solution “B”).

The ink formulation sprayed in trial #3 was performed utilizing an airbrush at 25-30 psi air assist pressure onto a heated (75° C.) 1″×3″ glass slide with silver electrodes spaced 1″ apart. The spacing provides two (2) measurements of sheet resistance and percent transmitted light on each slide. The application of SWCnT was performed until a predetermined amount (see trials) was applied to the glass substrate. The sheet resistance was measured using a 2 point probe ohmmeter and the light transmittance measured using a spectrophotometer at wavelength 550 nm. Measurements were taken at two (2) positions on the glass.

Formulation of Ink (T3):

5 ml ink solution “B”
0.5 ml 0.05% Pluronic Surfactant L64 (BASF)
   Sonicate 5 minutes
8.75 ml methanol
15 ml stock solution 1.75:1 methanol/DI Water
   Sonicate 5 minutes
SWCnT concentration in ink formulation was measured at 0.073 g/L (Absorbance=2.5)
   Trial 4

In trials #4, arc produced single walled carbon nanotube soot containing approximately 50-60% carbon nanotubes was purified by refluxing in 3M nitric acid solution for 18 hours at 145±15° C. The mixture was rinsed and centrifuged to produced an ink solution containing >99% single walled carbon nanotubes at a concentration of 0.198 g/L (ink solution “C”).

The ink formulation sprayed in trial #4 was performed utilizing an airbrush at 25-30 psi air assist pressure onto a heated (75° C.) 1″×3″ glass slide with silver electrodes spaced 1″ apart. This provides two (2) measurements of sheet resistance and percent transmitted light. The application of SWCnT was performed until a predetermined amount (see trials) was applied to the glass substrate. The sheet resistance was measured using a 2 point probe ohmmeter and the light transmittance measured using a spectrophotometer at wavelength 550 nm. Measurements were taken at two (2) positions on the glass.

Formulation of Ink (T4):

5 ml ink solution “C”
4 ml 4% L64 Pluronic surfactant (BASF)
   Sonicate 5 minutes
30 ml IPA
5 ml stock solution, 3:1 IPA/D.I.
   Sonicate 5 minutes
SWCnT concentration in ink formulation was measured at 0.025 g/L (Absorbance=0.8)

In trials #3 and #4 6.2 ml and 10 ml of the SWCnT ink solution T3 and T4 was applied to a glass slide, respectively. The sheet resistance was measured using a 2 point probe ohmmeter and the percent light transmitted was measured using a spectrophotometer. Next, the slide(s) was immersed in DI water for 1 minute, allowed to air dry and measured for sheet resistance and light transmittance. This process was repeated for a second rinse. The data is presented in the Table V. and VI. for trials #3 again shows in reduction in sheet resistance and increase in percent light transmittance after dipping the coated glass slide in water. The removal of the fugitive matrix allows the carbon nanotube network to reassemble (providing more contact between carbon nanotubes and ropes) while removing other impurities (which absorb light) not attached to the nano-fibrous network.

Preferred embodiments of the invention include:
Incorporating an expendable matrix (i.e. surfactant) into the coating and removing said matrix material from the layer containing the SWCNT resulting in increased optical, mechanical and electrical properties in these transparent conductive coatings.
Method of purification of a SWCNT coating by addition of expendable matrix (like surfactant) in the coated layer of SWCNT and subsequent removal of the matrix material along with other forms of carbon from the SWCNT layer.
Expendable matrix material include, but are not limited to, polymers, organic compounds, acids, salts, inorganic compounds, waxes, ceramics, and combinations and mixtures thereof.
Incorporation of specific particle geometries to effectively create defect sites in the single wall carbon nanotube coatings which can be subsequently removed by rinsing with water and or use of ultrasonic energy to form patterned holes.
Expendable matrix that can be removed by rinsing, e.g. methyl cellulose, non-ionic surfactants, anionic surfactants, cationic surfactants, and/or mixtures thereof.
Method of applying a wetting agent to an existing SWCNT layer to increase optical transparency.
Method of applying a wetting agent to an existing SWCNT layer and removal to decrease electrical resistivity.
Method of applying a wetting agent to an existing SWCNT layer, imparting ultrasonic energy, and drying to increase optical transparency.
The wetting agent may or may not contain a surfactant or other material which forms a solid on removal of wetting agent.
The wetting agent which contains an additional material which is also removed with the wetting agent. This material may comprise a second wetting agent, a surfactant, dispersant, colorant, absorbent, chemical reactant (e.g. oxidant, reducing agent, cross linking agent, dopant, antifungal, antibacterial, UV inhibitor), or combination thereof.
The wetting agent with one or more fluids which are removal by evaporation.
The wetting agent used on a SWCNT layer formed with or without expendable matrix material.
Method of applying a wetting agent to an existing SWCNT layer, imparting ultrasonic energy, and drying to increase optical transparency.
Method of applying a wetting agent to an existing SWCNT layer, imparting ultrasonic energy, and drying to decrease electrical resistivity.
Method of applying a wetting agent to an existing SWCNT layer, imparting energy to remove the wetting agent and decrease electrical resistivity and increase optical transparency.
A method of repeating the wetting process to further increase optical and electrical properties.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims.

TABLE I
Average Resistance and Percent Transmittance on 1 in × 3 in
glass slide with and without expendable matrix surfactant F68.

| | | |
|---|---|---|
| Slide A | Slide B | Slide C |
| without F68 | with F68 | with F68 |

| # of | Resistance | | Resistance | | Resistance | |
|---|---|---|---|---|---|---|
| rinses | (Ohm) | % T | (Ohm) | % T | (Ohm) | % T |
| 0 | 500 | 91.1 | 550 | 85.9 | 760 | 87.6 |
| 1 | 448 | 91 | 317 | 88.5 | 488 | 91 |
| 2 | 467 | 91.1 | 284 | 88.4 | 460 | 90.2 |
| 3 | 474 | 91.1 | 285 | 88.2 | 454 | 90.3 |
| 4 | 477 | 90.9 | 286 | 88.2 | 450 | 90.9 |

TABLE I
Data showing effect of wetting and sonicating a PET Film coated with
CNT

| Step | Seconds | | | % T @ 550 |
|---|---|---|---|---|
| Number | Sonicated | Medium | Ohms/Square | nm |
| 1 | 0 | Air | 443 | 85 |
| 2 | 3 | Water | 385 | 86 |
| 3 | 10 | Water | 377 | 87 |
| 4 | 10 | Water | 385 | 87 |
| 5 | 10 | Water | 389 | 87 |
| 6 | 30 | Water | 397 | 87 |
| 7 | 60 | Water | 414 | 87 |
| 8* | 10 | Toluene | NR | 87 |

*Silver leads cut off before sonication in toluene

TABLE II
Sheet Resistance and Percent Transmitted Light at 550 nm of
Trial 1 sample on glass slide.

| | Rₛ1 | Rₛ2 | | | Amount |
|---|---|---|---|---|---|
| | (Ohm/sq.) | (Ohm/sq.) | % T | % T | Applied (ml) |
| Start Dry | 1400 | 1800 | 87.4 | 88.8 | 10 |
| 1st rinse | 757 | 1200 | 89.7 | 91 | |
| 2nd rinse | 700 | 993 | 89.7 | 91.1 | |

TABLE III
Sheet Resistance and Percent Transmitted Light at 550 nm
of Trial 2 sample on glass slide.

| | Rₛ1 | Rₛ2 | | | Amount |
|---|---|---|---|---|---|
| | (Ohm/sq.) | (Ohm/sq.) | % T | % T | Applied (ml) |
| Start | 990 | 1200 | 77.6 | 81.4 | 10 |
| 1st rinse | 560 | 660 | 84.2 | 87 | |
| 2nd rinse | 529 | 619 | 84.1 | 87 | |

TABLE IV
Sheet Resistance and Percent Transmitted Light at 550 nm
of Trial 3 sample on glass slide.

| | R1 | R2 | % T | % T | mls |
|---|---|---|---|---|---|
| Dry | 3900 | 5300 | 78.6 | 80.8 | 6.2 |
| *1^{st} rinse | 571 | 804 | 80.4 | 83 | |
| *2^{nd} rinse | 456 | 625 | 80.3 | 83 | |

*Rinsed for 1 minute w/slight agitation, in D. I. water

TABLE V
Sheet Resistance and Percent Transmitted Light at 550 nm
of Trial 4 sample on glass slide.

| | R1 | R2 | % T | % T | mls |
|---|---|---|---|---|---|
| Dry | 8600 | 16200 | 74.8 | 83.2 | 10 |
| 1^{st} rinse | 524 | 769 | 86.4 | 88.9 | |
| 2^{nd} rinse | 476 | 719 | 86.4 | 88.9 | |

*Rinsed for 1 minute w/slight agitation, in D. I. water.

1. A method of purifying a coating containing carbon nanotubes comprising:
removing a matrix material and optionally other forms of carbon from a layer of carbon nanotubes.

2. The method of claim 1, wherein the carbon nanotubes are single-walled carbon nanotubes.
